(19) United States
(12) Patent Application Publication
(10) Pub. No.: US 2023/0256393 A1
(43) Pub. Date: Aug. 17, 2023

(54) SAMPLE CONCENTRATOR

(71) Applicant: POSTECH Research and Business Development Foundation, Pohang-si (KR)

(72) Inventors: Geunbae LIM, Gyeongju-si (KR); Hyukjin J. KWON, Yongin-si (KR); Minsoo LEE, lncheon (KR)

(21) Appl. No.: 17/940,172

(22) Filed: Sep. 8, 2022

(30) Foreign Application Priority Data
Sep. 9, 2021 (KR) 10-2021-0120552
Sep. 8, 2022 (KR) 10-2022-0114397

(51) Int. Cl. B01D 61/48; B01J 47/127; B01D 61/50

(52) U.S. Cl. CPC B01D 61/48; B01J 47/127; B01D 61/50

(57) ABSTRACT

A sample concentrator includes a lower frame and an upper frame coupled to overlap each other, wherein the lower frame includes a first electrode buffer channel and a second electrode buffer channel spaced apart from each other, a main channel formed in the lower frame and connecting the first electrode buffer channel to the second buffer channel, a first ion exchange membrane located between the first electrode buffer channel and the main channel, a second ion exchange membrane located between the second electrode buffer channel and the main channel, a first electrode electrically connected to the main channel with the first electrode buffer channel interposed therebetween, and a second electrode electrically connected to the main channel with the second electrode buffer channel interposed therebetween.

### TECHNICAL FIELD

The present invention relates to a sample concentrator, and more particularly, to a sample concentrator including an ion exchange membrane.

### BACKGROUND ART

Ion concentration polarization (ICP), which occurs at the interface between nanochannel/ion exchange membrane and microchannel (bulk fluid), is a representative electrokinetics phenomenon and has advantages of preprocessing samples through an intuitive and simple mechanism. Applied research into specific fields such as detection and diagnosis of trace target samples and continuous classification of target samples using ICP has been steadily conducted.

As for the basic mechanism of ICP, in nanochannels, a flow of ions, in particular, a flow of counter-ions having polarity opposite to the electrical polarity of the nanochannel, may be selectively allowed, unlike microchannels in which both fluids and ions are allowed to flow. This is because an overlap of electrical double layers induced in the vicinity of a channel wall surface occurs. Due to this, when the wall surface of the channel is positively charged, only negative ions are selectively allowed to pass therethrough, and when the wall surface of the channel is negatively charged, only positive ions are selectively allowed to pass therethrough, which is called ion permselectivity of the nanochannels.

When an electric field is applied to both ends of the nanochannel using ion selectivity, an ion depletion region with a very low ion concentration and an ion concentration region with a very high ion concentration are induced at both ends of the nanochannel. The ion depletion region acts as a large electrical resistance element, and most of the applied electric field is concentrated on the region. Accordingly, the charged particles approaching the ion depletion region receive a corresponding electric force (electrophoretic force) according to electrical polarity and electrophoretic mobility thereof.

Based on such electrokinetics, a sample concentrator may be realized by connecting two microchannels with a nanochannel and applying an electric field to both ends of the microchannel. Here, an ion depletion region is induced to the upper microchannel and an ion concentration region is induced to the lower microchannel.

When a fluid flows from the right side (positive potential applying unit) to the left side in an upper channel, a drag force and an electric force of the fluid act in opposite directions in the oppositely charged particles in the fluid reaching the ion depletion region. Accordingly, the particles stop at a point where the magnitudes of the velocity components based on the two forces are equal, and a concentration region (concentration band) is formed at the point. The concentration region is near an outer interface of the ion depletion region, and a distribution difference may occur depending on voltage, flow rate, and electrical characteristics (electrophoretic mobility) of particles.

When implementing a concentrator using these electrokinetic properties, the concentration of a positively charged sample may be implemented using a commercial anion exchange membrane, but the commercial anion exchange membrane includes only nanoscale pores, and thus, a fluid cannot flow in a normal direction penetrating through a membrane.

In addition, since the size and shape of the anion exchange membrane are standardized, it may be difficult to effectively apply the exchange membrane to systems having various sizes.

In addition, a negatively charged sample treatment device may be simply implemented by easily obtaining a commercially available cation exchange material, nafion, but, in the case of a positively charged sample device, there is no easily available anion exchange material, and thus, the anion exchange material may undergo a very complicated manufacturing or synthesizing process.

### DISCLOSURE

### Technical Problem

The present invention has been made in an effort to provide an apparatus having advantages of easily concentrating a positively charged sample by providing an anion exchange material that may be easily applied by omitting a complicated apparatus manufacturing process.

In addition, the present invention also provides a sample concentrator applicable to a micrometer size by expanding a limited application range due to low extensibility as a size and shape of an anion exchange membrane are standardized.

### Technical Solution

An exemplary embodiment of the present invention provides sample concentrator including a lower frame and an upper frame coupled to overlap each other, wherein the lower frame includes a first electrode buffer channel and a second electrode buffer channel spaced apart from each other, a main channel formed in the lower frame and connecting the first electrode buffer channel to the second buffer channel, a first ion exchange membrane installed across the main channel, a second ion exchange membrane located between the first electrode buffer channel and the main channel, a third ion exchange membrane located between the second electrode buffer channel and the main channel, a first electrode electrically connected to the main channel with the first electrode buffer channel interposed therebetween, and a second electrode electrically connected to the main channel with the second electrode buffer channel interposed therebetween.

The first ion exchange membrane includes pores having different sizes.

One side of the first ion exchange membrane may have a microfiber structure.

The microfiber structure may include fibers woven to be arranged in an irregular direction, rather than a uniform direction.

The microfiber structure may be a non-woven fabric.

The lower frame and the upper frame further may include slots facing each other, and the first ion exchange membrane, the second ion exchange membrane, and the third ion exchange membrane may be inserted into the slots formed in the lower frame and the upper frame.

The sample concentrator may further include an inlet and an outlet connected to the main channel and allowing a solution to be injected and discharged therethrough, wherein the inlet may be located between the first ion exchange membrane and the second ion exchange membrane, and the third ion exchange membrane may be located between the first ion exchange membrane and the outlet.

The sample concentrator may further include a syringe pump connected to the outlet, wherein the syringe pump may apply negative pressure to move a fluid in the main channel.

The first electrode may be connected to a ground, and the second electrode may be connected to a positive electrode.

The first ion exchange membrane, the second ion exchange membrane, and the third ion exchange membrane may be anion exchange membranes.

The third ion exchange membrane may include a plurality of micro hole patterns connected to the main channel.

The third ion exchange membrane may be installed across the main channel, and the second electrode buffer channel may be located on one side of the second ion exchange membrane located outside the main channel.

The second ion exchange membrane and the third ion exchange membrane may include nanopores.

The first electrode buffer channel, the second electrode buffer channel, and the main channel may be grooves formed in the lower frame.

### Advantageous Effect

According to the present invention, the sample concentrating device may be manufactured in a simple way, thereby saving cost and time.

In addition, an apparatus capable of easily concentrating a positively charged sample may be manufactured without a complicated apparatus manufacturing process.

In addition, since it is easy to form channels having various sizes, it is possible to expand an application range by manufacturing concentrators having various sizes and shapes.

### DESCRIPTION OF THE DRAWINGS

FIG. 1 is a perspective view schematically showing a concentrator according to an exemplary embodiment of the present invention.

FIG. 2 is a schematic plan view of a concentrating unit according to an exemplary embodiment of the present invention.

FIG. 3 is a photograph of a third ion exchange membrane according to an exemplary embodiment of the present invention.

FIG. 4 is a scanning electron microscope (SEM) photograph taken along line IV-IV′ of FIG. 3.

FIG. is a nanopore transmission electron microscope (TEM) photograph of the third ion exchange membrane of FIG. 3.

FIG. 6 is a view illustrating a process of concentration in the third ion exchange membrane according to an exemplary embodiment of the present invention.

FIGS. 7 and 8 are views illustrating an electroconvection generated in a microfiber structure according to an exemplary embodiment of the present invention.

FIG. 9 is a photograph of a microfiber structure according to an exemplary embodiment of the present invention.

FIG. 10 is a scanning electron microscope (SEM) photograph of the microfiber structure of FIG. 9.

FIGS. 11 and 12 are photographs showing the generation of electroconvection and sample concentration according to the presence or absence of a microfiber structure according to an exemplary embodiment of the present invention.

FIG. 13 is a photograph showing a result of concentrating a positively charged sample according to an exemplary embodiment of the present invention.

FIG. 14 is a graph showing a result of concentrating a positively charged sample according to an exemplary embodiment of the present invention.

FIG. 15 is a photograph showing a result of concentrating protein particles according to an exemplary embodiment of the present invention.

FIG. 16 is a graph showing a result of concentration of protein particles according to an exemplary embodiment of the present invention.

### MODE FOR INVENTION

Hereinafter, exemplary embodiments of the present invention will be described in detail with reference to the accompanying drawings to allow those skilled in the art to practice the present invention. The present invention may be implemented in various different forms and is not limited to the examples as described herein.

The size and thickness of each component shown in the drawings may be arbitrarily shown for convenience of explanation, and therefore, the present invention is not necessarily limited to the shown exemplary embodiments in the drawings.

In the drawings, the thickness of layers, films, panels, regions, etc., are exaggerated for clarity. In the drawings, the thickness of partial layers and regions may be exaggerated for convenience of explanation. It will be understood that when an element such as a layer, film, region, or substrate is referred to as being “on” another element, it may be directly on the other element or intervening elements may also be present.

In addition, unless explicitly described to the contrary, the word “comprise”, and variations such as “comprises” or “comprising”, will be understood to imply the inclusion of stated elements but not the exclusion of any other elements.

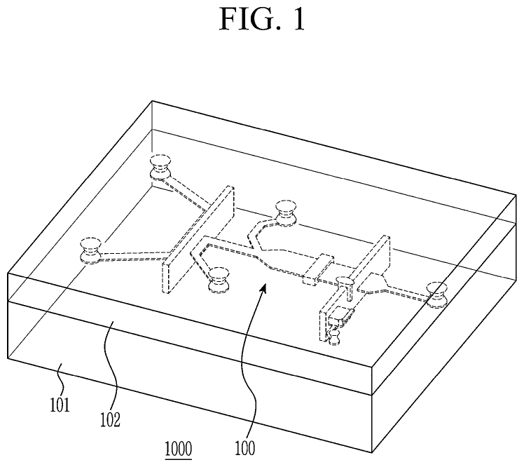

FIG. 1 is a perspective view schematically showing a concentrator according to an exemplary embodiment of the present invention.

As shown in FIG. 1, a concentrating unit 1000 according to an exemplary embodiment of the present invention includes upper and lower frames 101 and 102 coupled to face each other. The lower frame 102 includes a concentrating unit 100 including channels and slots (not shown), an anion exchange membrane and a microfiber structure installed in the channels and slots.

A lower slot, a slot corresponding to a channel, and the channel may be formed in the upper frame 101.

A main channel 10 is a passage through which a fluid actually flows, and is formed to be concave in the lower frame 102. The slot, which is for fixing a position of the ion exchange membrane installed in the channel, may be fixed in position as the ion exchange membrane is inserted into the upper frame 101 and the lower frame 102 and may be formed to a depth by which the upper frame 101 and the lower frame 102 are not separated after the upper and lower frames are attached.

The upper and lower frames 101 and 102 may be manufactured using polydimetysiloxane (PDMS). For example, PDMS may be injected into a mold manufactured by a 3D printing method and cured, and thereafter, the mold may be removed to manufacture the upper and lower frames 101 and 102. The upper and lower frames 101 and 102 may be irreversibly bonded by an oxygen plasma treatment to prevent leakage between the upper and lower frames by fluid pressure.

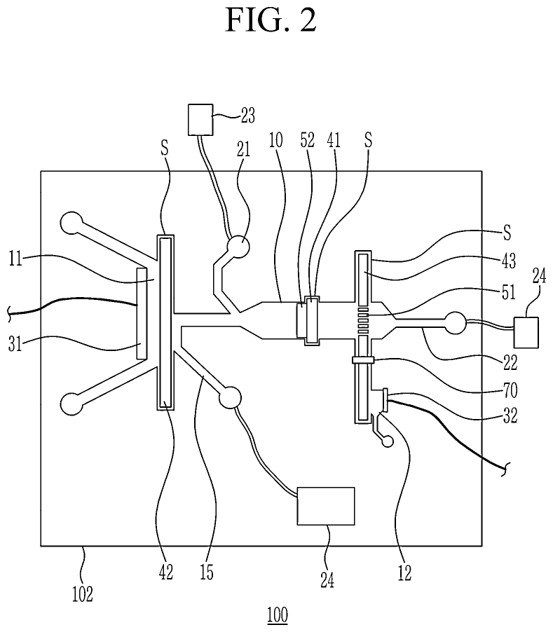

An anion exchange membrane and a microfiber structure may be inserted into the channels and slots S (refer to FIG. 2) of the lower frame 102.

After the anion exchange membrane and the microfiber structure are inserted into the slots, the oxygen plasma treatment may be performed on contact surfaces of the upper and lower frames for irreversible bonding. That is, after the anion exchange membrane and the microfiber structure are inserted into the lower frame 102, the upper frame 101 may be aligned and covered, the upper and lower frames are bonded by irreversible bonding by the oxygen plasma treatment, and then, a heat treatment may be performed to increase bonding strength.

FIG. 2 is a schematic plan view of the concentrating unit according to an exemplary embodiment of the present invention.

Referring to FIG. 2, the concentrating unit 100 according to an exemplary embodiment of the present invention includes the main channel 10 for treating a solution-type sample and electrode buffer channels 11 and 12 including an electrode. In this case, the main channel 10 and the electrode buffer channels 11 and 12 may be grooves formed in the upper frame and the lower frame (refer to FIG. 1).

The main channel 10 has an inlet 21 and an outlet 22 through which the solution is injected and discharged. A sample reservoir 23 may be connected to the inlet 21, and a syringe pump 24 may be connected to the outlet 22.

A fluid may be moved by applying negative pressure through the syringe pump 24 connected to the outlet 22.

The electrode buffer channels 11 and 12 are installed between the electrodes 31 and 32 and the main channel 10 to prevent byproducts occurring due to an electrochemical reaction of the electrodes from flowing into the main channel 10 and adversely affecting the solution treatment, and the electrodes 31 and 32 are connected to the main channel 10 through the electrode buffer channels 11 and 12.

The electrode buffer channels 11 and 12 include a first electrode buffer channel 11 connected to the first electrode 31 and a second electrode buffer channel 12 connected to the second electrode 32.

The main channel 10 is connected to the first electrode 31 with the first electrode buffer channel 11 interposed therebetween, and the second electrode buffer channel 12 is connected to the second electrode 32 with an anion exchange membrane 43 (to be described below) located outside the main channel 10 interposed therebetween. The first electrode 31 may be a ground, and the second electrode 32 may be a positive electrode.

A flushing channel 15 is connected to the main channel 10, and a syringe pump 24 is connected to the flushing channel 15.

The flushing channel 15 may be configured to eliminate an ion concentration region formed on a surface of the opposite side between the first electrode buffer channel 11 and the ion exchange membrane, that is, on a surface of the first ion exchange membrane 41 facing the main channel 10. By generating a flow of fluid through the flushing channel, ions accumulated in the ion concentration region may be continuously removed.

Anion exchange membranes (AEMs) 41, 42, and 43 are installed between the main channel 10 and the electrode buffer channels 11 and 12 to control a fluid flow, such as blocking or permitting a fluid flow therebetween.

The anion exchange membranes 41, 42, and 43 include a first anion exchange membrane 41 located in the center of the main channel 10, and a second anion exchange membrane 42 and a third anion exchange membrane 43 located on opposite sides with the first anion exchange membrane interposed therebetween. The anion exchange membranes 41, 42, and 43 may be inserted into the slot S to be fixed, and the slot S may be a groove formed across the channel and connected to the main channel 10.

The second anion exchange membrane 42 is located between the first electrode buffer channel 11 and the main channel 10, and the third anion exchange membrane 43 may be located between the second electrode buffer channel 12 and the main channel 10. The second anion exchange membrane 42 is located on one side of the main channel 10, that is, between the first electrode buffer channel 11 and the main channel 10, and the second anion exchange membrane 42 is a commercial anion exchange membrane including nanopores.

The third anion exchange membrane 43 may be disposed across the main channel 10, and the second electrode buffer channel 12 may be located to be in contact with one side of the third anion exchange membrane 43 located outside the main channel 10. Here, the third anion exchange membrane 43 is a commercial anion exchange membrane including nanopores.

In the third anion exchange membrane 43, a micro hole pattern 51 is formed at an interface with the main channel 10 so that the fluid may be guided to the outlet 22 of the main channel 10.

A blocking layer 70 for blocking fluid leakage between the main channel 10 and the second electrode buffer channel 12 may be formed. The blocking layer 70 is located outside the third ion exchange membrane 43 and may be formed by injecting epoxy into a region for blocking the flow of fluid with a syringe.

Meanwhile, the first anion exchange membrane 41 is located in the center of the main channel 10 and is a porous anion exchange membrane including micropores as well as nanopores.

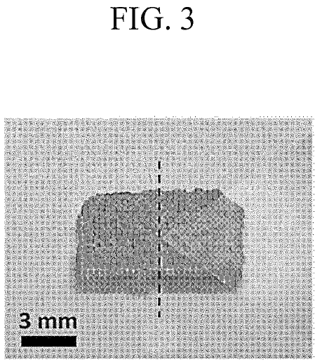

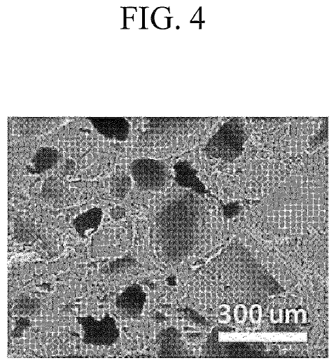

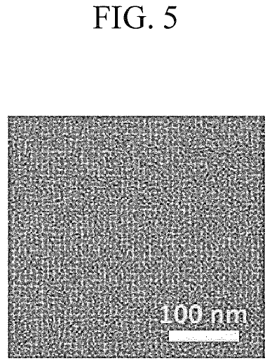

FIG. 3 is a photograph of a first ion exchange membrane according to an exemplary embodiment of the present invention, FIG. 4 is a scanning electron microscope (SEM) photograph taken along line IV-IV′ of FIG. 3, and FIG. 5 is a nanopore transmission electron microscope (TEM) photograph of the third ion exchange membrane of FIG. 3.

Referring to FIGS. 2 to 5, the first anion exchange membrane 41 according to an exemplary embodiment of the present invention includes micropores, as well as nanopores, unlike the second anion exchange membrane 42 and the third anion exchange membrane 43, which are commercial anion exchange membranes.

Since the first anion exchange membrane 41 includes pores having various sizes, both ions and a fluid may flow therethrough. The first anion exchange membrane 41 is manufactured to have a desired size and shape by a casting technique, and since the first anion exchange membrane 41 includes pores having various sizes, both ions and a fluid may flow therethrough.

In the casting technique, a polyester resin, PPO−, TMA+ solution, and NaCl powder to form an ion exchange membrane are mixed, poured into a mold, and cured to form a required ion exchange membrane form. Thereafter, a resultant structure is immersed in a deionized water to dissolve NaCl crystals to be removed, so that the first ion exchange membrane 41 having pores having various sizes may be manufactured.

The porous first anion exchange membrane 41 according to an exemplary embodiment of the present invention allows an electric field distribution region (ion depletion region) in the main channel 10 to be induced to the pores serving as channels.

When the first anion exchange membrane 41 is formed as a porous anion exchange membrane including nanopores and micropores, a number of nanopores and micropores may be connected in parallel, achieving an effect that a number of channels are connected in parallel.

That is, a number of nanopores included in the first anion exchange membrane 41 become channels, and an ion depletion region is formed in each channel. In addition, as numerous nanochannels form a parallel-connected structure, the ion depletion regions formed in the respective channels are merged to form an ion depletion region in a channel larger than a millimeter in size. In addition, as a fluid moves into the micropores, an ion depletion region may be formed while continuously injecting a fluid other than a predetermined amount of fluid.

Since such a porous anion exchange membrane may be easily manufactured to have a required size, a manufacturing process of concentrators having various sizes may be simplified by inserting such a porous anion exchange membrane into a main channel of a positively charged sample device having a variety of sizes from micrometers to macros.

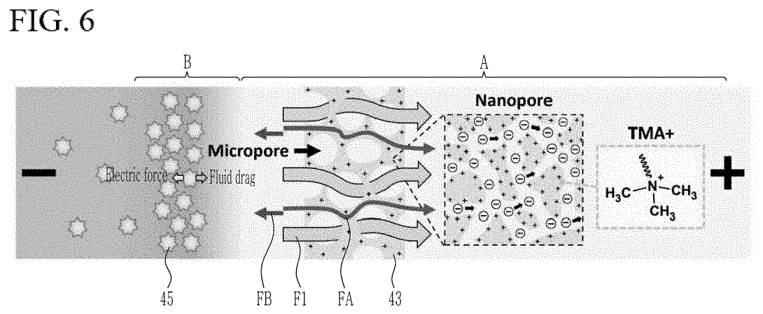

FIG. 6 is a view illustrating a process of concentration in the first anion exchange membrane according to an exemplary embodiment of the present invention.

Referring to FIGS. 2 and 6, the first anion exchange membrane 41 is located in the middle of the main channel 10 through which the fluid may pass. At this time, it is assumed that a flow F1 of the fluid is formed in a left-to-right direction and an electric field is formed in a leftward direction in the drawing.

As an electric field is applied to the main channel 10, anions in the fluid move in a positive electrode direction FA, that is, a second electrode buffer channel 32 direction, through the nanopores based on anion selectivity of the first anion exchange membrane 41, and an ion depletion region A is formed on the left side of the first anion exchange membrane 41. On the positively charged particles 45 approaching the ion depletion region, a fluid drag and an electric force act in opposite directions to each other, and the positively charged particles 45 stop at a point where magnitudes of the velocity components by the two forces are equal.

Accordingly, a particle concentration region B is formed in the vicinity of an interface of the ion depletion region A.

In an exemplary embodiment of the present invention, the ion concentration region B is not formed on the right side of the first anion exchange membrane 41, but formed on the left side of the first anion exchange membrane 41. In addition, the ion depletion region A appears to continuously expand to a downstream of the main channel. This means that, as the first anion exchange membrane 41 allows the fluid flow F1, the ion depletion region formed on the left side of the first anion exchange membrane 41 extends to the right side of the first anion exchange membrane 41 along the fluid flow.

Referring back to FIG. 2, a microfiber structure 52 may be installed on one side of the first anion exchange membrane 41 in order to reduce the effect of electroconvection in the main channel 10. The microfiber structure 52 may be a non-woven mat in which fibers do not have a specific direction.

When the first anion exchange membrane 41 is installed as in the exemplary embodiment of the present invention, the channel may be widened, but as the channel is widened, a uniform and stable ion depletion region may not be properly formed. This is because, when the size of the main channel increases beyond a millimeter scale, strong electroconvection inevitably occurs near the exchange membrane due to electroosmotic instability (EOI).

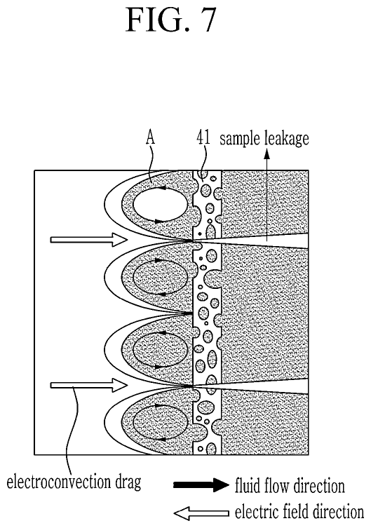

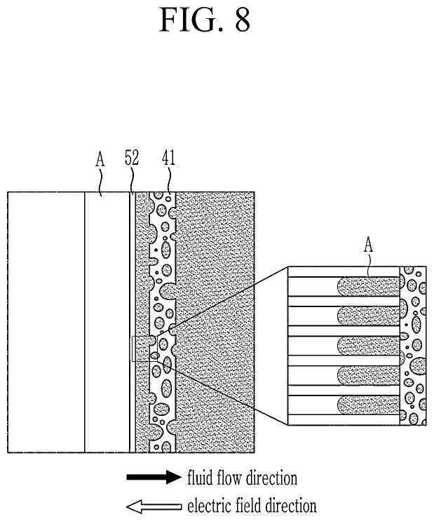

FIGS. 7 and 8 are views illustrating the generation of electroconvection in the microfiber structure according to an exemplary embodiment of the present invention.

Referring to FIG. 7, an ion depletion region D1 shaken in a semi-sphere form may be formed in front of the first anion exchange membrane 41 due to electroconvection, which is accompanied by an electroconvective drag to cause leakage of the sample, making it impossible to efficiently concentrate a solution.

Therefore, as shown in FIG. 8, by installing the microfiber structure 52 in front of the first anion exchange membrane 41, electrioconvection may be effectively controlled.

The microfiber structure 52 may obtain the effect of changing the main channel 10 into a number of microchannels when the main channel 10 is enlarged to a millimeter size. Accordingly, a uniform and stable ion depletion region is formed even in the wide main channel 10 having a millimeter size, and leakage of the sample does not occur.

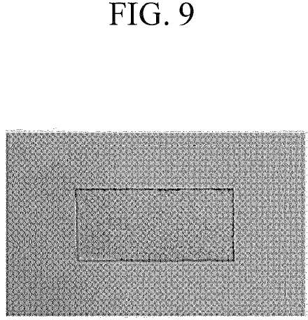

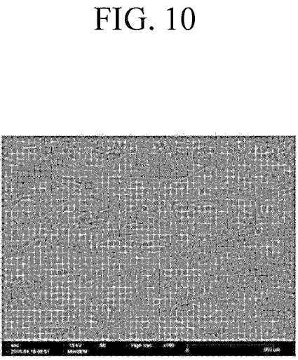

FIG. 9 is a photograph of the microfiber structure according to an exemplary embodiment of the present invention, and FIG. 10 is a scanning electron microscope (SEM) photograph of the microfiber structure of FIG. 9.

Referring to FIGS. 9 and 10, the microfiber structure is a structure in which fiber strands of several hundred nanometers to several micrometers are irregularly entangled, and includes numerous microscale effective pores.

As the nanopores and micropores of the first anion exchange membrane may be regarded as nanochannels and microchannels, the micropore distribution of the microfiber structure may also be regarded as the distribution of microchannels. In this manner, when the microfiber structure is installed in the main channel 10 (refer to FIG. 2), an effect of changing one main channel into a channel structure in which numerous nanochannels and microchannels are in parallel with each other may be expected, and accordingly, a uniform synthetic ion depletion region may be formed throughout the channels without the occurrence of electroconvection.

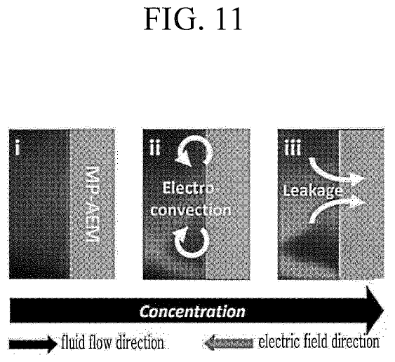

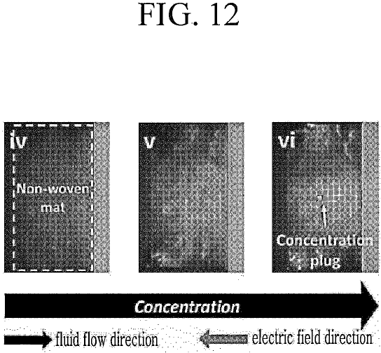

FIGS. 11 and 12 are photographs showing the generation of electrical convection and sample concentration according to the presence or absence of a microfiber structure according to an exemplary embodiment of the present invention.

As shown in FIG. 11, it can be seen that, when a microfiber structure is not installed, electroconvection actively occurs and continuous leakage of the sample (refer to the red fluorescent color) occurs. Meanwhile, it can be seen that, when the microfiber structure is installed as shown in FIG. 12, electroconvection is suppressed to form a uniform ion depletion region, and sample concentration is effectively performed.

As such, if the sample concentrator is manufactured as in the exemplary embodiment of the present invention, the sample may be stably concentrated, while omitting processes such as photolithography, photopolymerization, and surface modification, so that time and cost may be saved.

In addition, in an exemplary embodiment of the present invention, the concentrator may be manufactured to have various shapes and sizes by the 3D printing method.

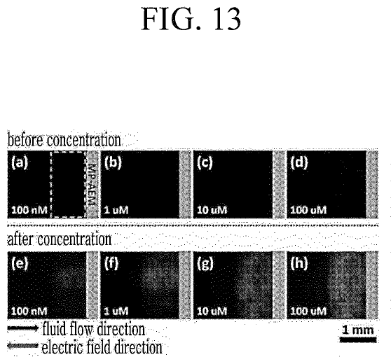

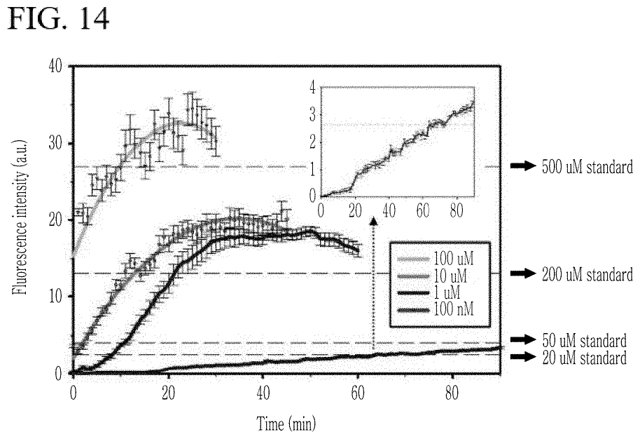

FIG. 13 is a photograph showing a result of concentrating a positively charged sample according to an exemplary embodiment of the present invention, and FIG. 14 is a graph showing a result of concentrating a positively charged sample according to an exemplary embodiment of the present invention.

In FIGS. 13 and 14, a sample included cationic fluorescent particles, and was concentrated under conditions of initial sample concentrations of 100 nM, 1 μM, 10 μM, and 100 μM. A strength and flow rate of an electric field were appropriately adjusted so that a sample concentration region was formed on a nonwoven fabric.

Formation patterns of the concentration region before and after concentration were different for each initial sample concentration condition. It can be seen that, as the initial sample concentrations increased to 100 nM, 1 μM, μM, and 100 μM, the concentration region gradually expanded as shown in the picture after concentration. At this time, it can be seen that, at 100 nM, which is the highest initial sample concentration, a concentration region is formed throughout the nonwoven fabric.

In addition, At this time, a maximum concentration rate was about 500 at the initial concentration of 100 nM.

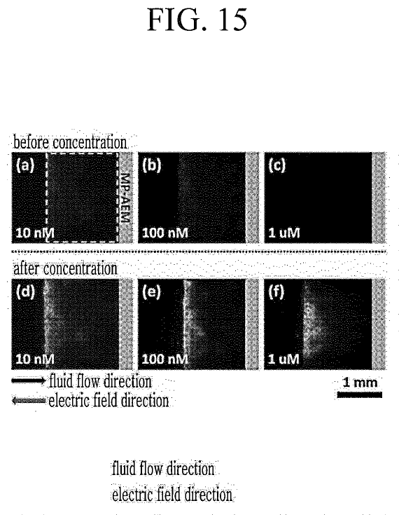

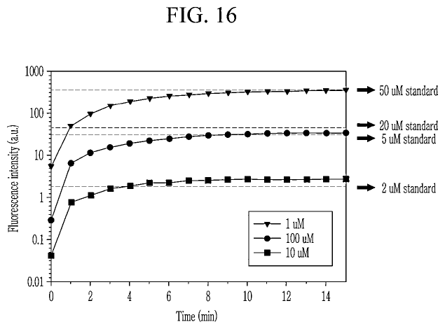

FIG. 15 is a photograph showing a result of concentrating protein particles according to an exemplary embodiment of the present invention, and FIG. 16 is a graph showing a result of concentration of protein particles according to an exemplary embodiment of the present invention.

In FIGS. 15 and 16, the sample included protein particles, and the sample was concentrated at three initial sample concentrations of 10 nM, 100 nM, and 1 μM. A strength and flow rate of the electric field were appropriately adjusted so that a sample concentration region is formed on the nonwoven fabric.

The concentration region of the protein particles appeared narrower and thinner than that of the fluorescent particles, which is due to a difference in particle size and diffusivity. Protein particles with relatively large particle sizes and low diffusivity were concentrated in a local region.

Formation patterns of the concentration region before and after concentration were different for each initial sample concentration condition, and it can be seen that, as the initial sample concentrations increased to 10 nM, 100 nM, and 1 μM, the concentration region gradually expanded as shown in the picture after concentration. At this time, a maximum concentration rate was about 250 at the initial concentration of 10 nM.

While the inventive technology has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

1. A sample concentrator comprising:
a lower frame and an upper frame coupled to overlap each other,
wherein the lower frame includes
a first electrode buffer channel and a second electrode buffer channel spaced apart from each other;
a main channel formed in the lower frame and connecting the first electrode buffer channel to the second buffer channel;
a first ion exchange membrane installed across the main channel
a second ion exchange membrane located between the first electrode buffer channel and the main channel;
a third ion exchange membrane located between the second electrode buffer channel and the main channel;
a first electrode electrically connected to the main channel with the first electrode buffer channel interposed therebetween; and
a second electrode electrically connected to the main channel with the second electrode buffer channel interposed therebetween.

2. The sample concentrator of claim 1, wherein:
the first ion exchange membrane includes pores having different sizes.

3. The sample concentrator of claim 2 wherein:
one side of the first ion exchange membrane has a microfiber structure.

4. The sample concentrator of claim 3 wherein:
the microfiber structure includes fibers woven to be arranged in an irregular direction, rather than a uniform direction.

5. The sample concentrator of claim 4 wherein:
the microfiber structure is a non-woven fabric.

6. The sample concentrator of claim 2 further comprising:
the lower frame and the upper frame further include slots facing each other, and
the first ion exchange membrane, the second ion exchange membrane, and the third ion exchange membrane are inserted into the slots formed in the lower frame and the upper frame.

7. The sample concentrator of claim 2, further comprising:
an inlet and an outlet connected to the main channel and allowing a solution to be injected and discharged therethrough,
wherein the inlet is located between the first ion exchange membrane and the second ion exchange membrane, and
the third ion exchange membrane is located between the first ion exchange membrane and the outlet.

8. The sample concentrator of claim 7, further comprising:
a syringe pump connected to the outlet,
wherein the syringe pump applies negative pressure to move a fluid in the main channel.

9. The sample concentrator of claim 7, wherein:
the first electrode is connected to a ground, and the second electrode is connected to a positive electrode.

10. The sample concentrator of claim 2, wherein:
the first ion exchange membrane, the second ion exchange membrane, and the third ion exchange membrane are anion exchange membranes.

11. The sample concentrator of claim 1, wherein:
the third ion exchange membrane includes a plurality of micro hole patterns connected to the main channel.

12. The sample concentrator of claim 1, wherein:
the third ion exchange membrane is installed across the main channel, and
the second electrode buffer channel is located on one side of the second ion exchange membrane located outside the main channel.

13. The sample concentrator of claim 1, wherein:
the second ion exchange membrane and the third ion exchange membrane include nanopores.

14. The sample concentrator of claim 1, wherein:
the first electrode buffer channel, the second electrode buffer channel, and the main channel are grooves formed in the lower frame.
